(19) United States
(12) Patent Application Publication
(10) Pub. No.: US 2016/0286135 A1
(43) Pub. Date: Sep. 29, 2016

(54) Surveillance and Tracking Device

(71) Applicant: Eslam Abbas Baseuny, Asyut (EG)

(72) Inventor: Eslam Abbas Baseuny, Asyut (EG)

(21) Appl. No.: 15/067,563

(22) Filed: Mar. 11, 2016

Related U.S. Application Data
(60) Provisional application No. 62/138,386, filed on Mar. 26, 2015.

(51) Int. Cl. H04N 5/247; H04B 1/06; H02J 7/02; B64C 39/02; B64D 47/08; B64F 1/36; H04B 1/02; G06K 9/00

(52) U.S. Cl. CPC H04N 5/247; H04B 1/02; H04B 1/06; G06K 9/0063; G06K 9/00771; B64C 39/024; B64D 47/08; B64F 1/362; H02J 7/025; B64C 2201/127; B64C 2201/146; B64C 2201/066; B64C 2201/042

(57) ABSTRACT

A surveillance and tracking device (10) comprises a nest (12) holding a secondary camera (20) and a drone (14) holding a primary camera (18). Both cameras provide the operator (16) with a real time video or photos. While the secondary camera (20) surveys the local field in which the nest (12) is installed, the drone (14) can fly during the active stage of the functionality of the device (10) to follow up certain events or persons using the primary camera (18). The drone (14) can also perform routine surveillance of targeted fields. This large scale capability of the presented device (10) enables the operator (16) to perform a flexible, sustainable and more effective surveillance process. And so; the device (10) can deal up with the massively elaborated danger diversity and security challenges of the current era.

### CROSS-REFERENCE TO RELATED APPLICATIONS

This application claims the benefit of Provisional Patent Application No. 62/138,386 filed 26 Mar. 2015 by the present inventor.

### STATEMENT REGARDING FEDERALLY SPONSORED RESEARCH OR DEVELOPMENT

Not Applicable.

### REFERENCE TO SEQUENCE LISTING, A TABLE, OR A COMPUTER PROGRAM LISTING COMPACT DISC APPENDIX

Not Applicable.

### DESCRIPTION

1. Field of the Invention

The present invention relates to the security and surveillance technology more particularly, by combining the security camera technology with the unmanned aerial vehicles (UAV) technology.

2. Background of the Invention

With the current security challenges, the demand for more effective security devices increases rapidly to deal up with the massively elaborated danger diversity. Surveillance cameras are considered a cornerstone of the modern security concept. They are used to observe and monitor certain areas to update an operator with a real time video or photos. They are very helpful in the fight on crime by taking photos, or live video of a targeted field.

The “more effective” surveillance cameras should have two major characteristics, flexibility and sustainability. Herein, the flexibility means enabling the operator not only to passively observe but also to actively monitor the sequel of the events. So it refers to the ability of the camera to cover a wider area than its scope and follow up certain events or persons. The sustainability refers to the ability to maintain this flexible functionality round the clock.

None of the prior art provides a surveillance or security camera that combines both characteristics. Indeed, the presence of one characteristic always detains the presence of the other. CCTV cameras have sustainability as they can maintain functionality around the clock while lack flexibility as they can't exceed the camera's scope during the surveillance process. Surveillance UAVs (drones), used by police and security forces, have flexibility as they can cover a wider area and follow up certain events or persons, yet they lack sustainability of maintaining this flexible functionality round the clock.

### SUMMARY OF THE INVENTION

The present invention seeks to provide surveillance and tracking device that combines the fixed cameras (as CCTVs) and the drones. This combination leads to functionality synergism as it not only adds the advantages of both apparatuses, but also avoids the deficits of each of which. Thus, this combination gives rise to a more effective device that is functionally flexible and sustainable.

The presented device comprises a mobile component, a fixed component and at least one camera. The fixed component is a station, and the mobile component is a drone incubated within. The cameras are installed essentially into the drone and additionally into the station. They may be ordinary or thermographic. Hereinafter; the station is called the nest. In a preferred embodiment; the nest holds a secondary camera and the drone holds a primary camera. The present invention provides the nest as the crucial part of the device, as it holds the drone as an incubator helping it to maintain functionality by supplying power, control orders and data stream transfer. The nest is a moderator between the drone and the operator.

The presented device performs the surveillance process using two cameras, in preferred embodiments, the secondary of the nest and the primary of the drone. Both cameras update the operator with real time videos and photos. The surveillance process alters between two different stages of functionality, dormant and active surveillance (or tracking process). During the dormant stage, the drone is incubated within the nest. The secondary camera of the nest performs passive real time surveillance in the field in which the nest is installed. Hereinafter; this field is defined as the local field. So during this stage; the device resembles a simple security, or surveillance, camera. The nest processes and transmits data stream from the secondary camera to the operator.

When active surveillance is put into action, the drone flies away from the nest and uses the installed primary camera to perform a real time active surveillance of multiple fields, and follow up certain events or persons. It depends on a battery as a power supply, a video transmitter to transmit surveillance data to the nest, and also a radio receiver to get control orders. The aviation of the drone may be automatic which occurs according to a pre-saved protocol installed on the hardware of the nest or the drone itself in an alternative embodiment, or may be a manual control from the operator using the nest as a relay station. Using the nest as a moderator between the drone and the operator provides higher flexibility as the operator is not constrained to certain aviation-control field that depends on the advancement of the radio and video transmitter/receiver sets. The nest is the actual drone controller and the data receiver of the device. The nest depends on orders from the operator that can be transmitted to the drone or processed and saved on the control board as previously mentioned.

The regular drone, of the prior art, lacks sustainability due to energy depletion and also has a limited flexibility due to operator-dependent processes of recharging and aviation. The present invention takes the advantage of sustainability by using fixed recharging incubators, the nests. Also; the present invention takes the advantage of flexibility, as it uses the incorporated control broad of the nest to perform programmed operator-free processes. For example, it can perform a GPS-dependent routine aviation, and also recharging process. Also the previously mentioned alternation between both dormant passive and active stages of the surveillance function of the present device is a point of superiority over both regular surveillance drones, and fixed security cameras of the prior art.

The main idea of the present invention is the combination between a drone-dependent surveillance process, and another nest-dependent one. The present device can be used as a single unit or as an incorporated network of multiple devices. Within this network, the nests not only perform a passive surveillance of the targeted local fields, but also are used as fixed relay stations and connecting links between the drones and the operator. This team work among the devices within an interconnected network provides the operator with large scale of new abilities which considered the main aim of the manufacturer.

As surveillance and tracking device; the present invention provides superiorities over both fixed security cameras and surveillance drones. Simply, it surpasses fixed cameras as it has a mobile component and surpasses surveillance drones as it can sustain functionality. In other words; the present invention is a combination of both in one device, so it provides a sustained surveillance process of wider and multiple fields.

As additional advantages; the present device, via its drone, can provide a real time follow up of a certain event either according to a program or under operator control. Also, the drone can be sent according to the order of the operator to aimed hot spots using GPS. Also, it can perform a programmed routine fly depending on GPS according to a previously defined course by the operator saved into the control board of the nest.

### SUMMARY OF THE DRAWINGS

In the drawings, closely related figures have the same number but different alphabetic suffixes.

FIG. 1 is a schematic diagram that shows the functional relation between the device's nest and drone with each other, and with the operator in a preferred embodiment.

FIGS. 2A to 2E show, in multiple views, the surveillance and tracking device in a preferred embodiment; where:

FIG. 2A is a prospective lateral view of the device showing the external parts.

FIG. 2B is a prospective superior view of the device showing the external parts.

FIG. 2C is a sectional view of the device showing an empty nest. The figure shows parts of the nest from the lateral view.

FIG. 2D is a sectional view of the device showing the nest and the drone incubated within. The figure shows parts of the nest and the drone from the lateral view.

FIG. 2E is a sectional view of the device showing an empty nest. The figure shows parts of the nest from the superior view.

FIGS. 3A to 3E show, in multiple views, an advantageous embodiment of the surveillance and tracking device; where:

FIG. 3A is a prospective lateral view of the device showing the external parts.

FIG. 3B is a prospective superior view of the device showing the external parts.

FIG. 3C is a sectional view of the device showing an empty nest. The figure shows parts of the nest from the lateral view.

FIG. 3D is a sectional view of the device showing the nest and the drone incubated within. The figure shows parts of the nest and the drone from the lateral view.

FIG. 3E is a sectional view of the device showing an empty nest. The figure shows parts of the nest from the superior view.

FIGS. 4A to 4F show, in multiple views, an alternative mono-camera embodiment of the device; where:

FIG. 4A is a prospective lateral view of the device showing an empty nest. The figure shows the external parts of the nest.

FIG. 4B is a prospective superior view of the device showing an empty nest. The figure shows the external parts of the nest.

FIG. 4C is a prospective lateral view of the device showing the nest and the drone in combination.

FIG. 4D is a prospective superior view of the device showing the nest and the drone in combination.

FIG. 4E is a sectional view of the device showing an empty nest. The figure shows parts of the nest from the lateral view.

FIG. 4F is a sectional view of the device showing an empty nest. The figure shows parts of the nest from the superior view.

FIGS. 5A to 5E show, in multiple views, another alternative mono-camera embodiment of the device, where:

FIG. 5A is a prospective lateral view of the device showing an empty nest. The figure shows the external parts of the nest.

FIG. 5B is a prospective superior view of the device showing an empty nest. The figure shows the external parts of the nest.

FIG. 5C is a sectional view of the device showing an empty nest. The figure shows parts of the nest from the lateral view.

FIG. 5D is a sectional view of the device showing the nest and the drone in combination. The figure shows parts of the nest and the drone from the lateral view.

FIG. 5E is a sectional view of the device showing an empty nest. The figure shows parts of the nest from the superior view.

FIG. 6 is a sectional view of the drone showing parts related to control, communication and powering processes, from the superior view.

FIG. 7 is a partial view of the drone showing the primary camera.

FIGS. 8A to 8D show, in multiple views, a modified nest which can be configured to standalone as a separate apparatus for stationing of drones to maintain its functionality; where:

FIG. 8A is a prospective lateral view of the apparatus showing the external parts.

FIG. 8B is a prospective superior view of the apparatus showing the external parts.

FIG. 8C is a sectional view of the apparatus showing its parts from the lateral view.

FIG. 8D is a sectional view of the apparatus showing its parts from the superior view.

FIG. 9 is a schematic view showing a method of surveillance and tracking.

### DRAWING—REFERENCE NUMBERS

10. Surveillance and tracking device.
12. Nest (Station).
14. Drone.
16. Operator.
18. Primary camera.
20. Secondary camera.
22. Body of the nest.
24. Control board of the nest.
26. Radio transmitter.
28. Video receiver.
30. Inductive coil.
32. Alarm device.
34. Lamp of the alarm device.
36. Antenna.
38. Floor of the nest.
40. T-shaped electric magnet.
42. Lateral wall of the nest.
44. Anterior wall of the nest.
46. Automatic gate.
48. Opening of the cables.
50. Installation Pillar.
52. Protective glass of the secondary camera.
54. Limb of the nest.
56. Body of the drone.
58. Flight control board of the drone.
60. Receiver coil.
62. Radio receiver.
64. Video transmitter.
66. Battery.
68. Gimbals.
70. Landing skid.
72. Frame of the drone.
74. Electric Motors.
76. Propellers.
78. Protective glass of the primary camera.
80. Base of the nest.
82. Horn of the base.
84. U-shaped electric magnet.
86. Hole.
88. Lateral fence of the nest.
90. Balcony of the nest.
92. Control board of the primary camera.
94. Anti-vibration mounts.

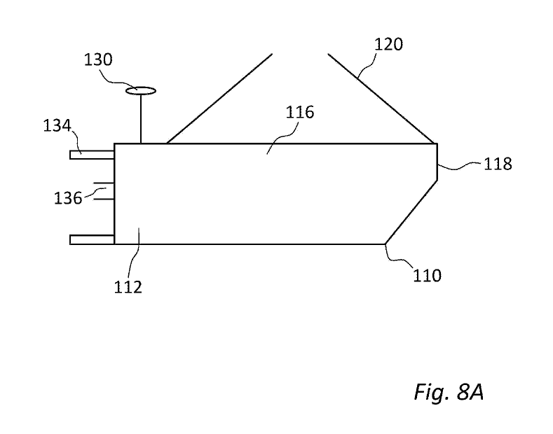

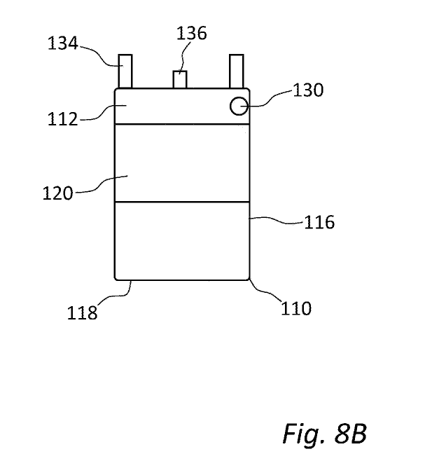

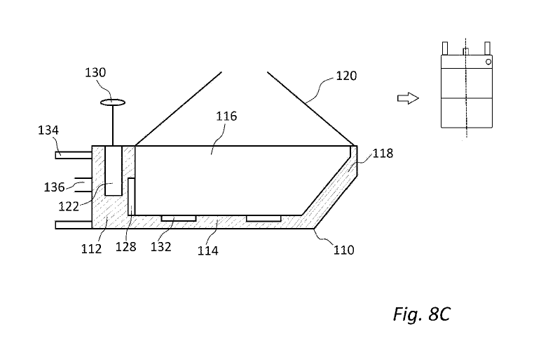

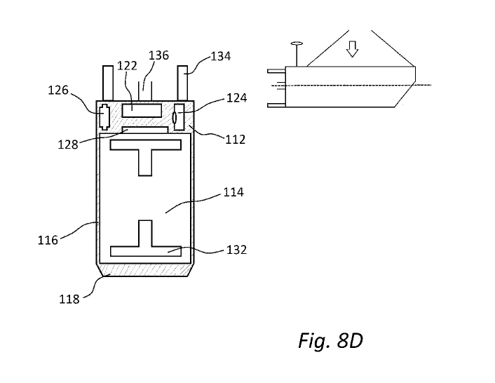

Reference numbers of the standalone apparatus of FIG. 8:
110. Standalone apparatus.
112. Body.
114. Floor.
116. Lateral wall.
118. Anterior wall.
120. Gate.
122. Control board.
124. Radio transmitter.
126. Video receiver.
128. Inductive coil.
130. Antenna.
132. Electric magnet.
134. Installation pillars.
136. Opening of the cables.

### DETAILED DESCRIPTION OF THE DRAWINGS

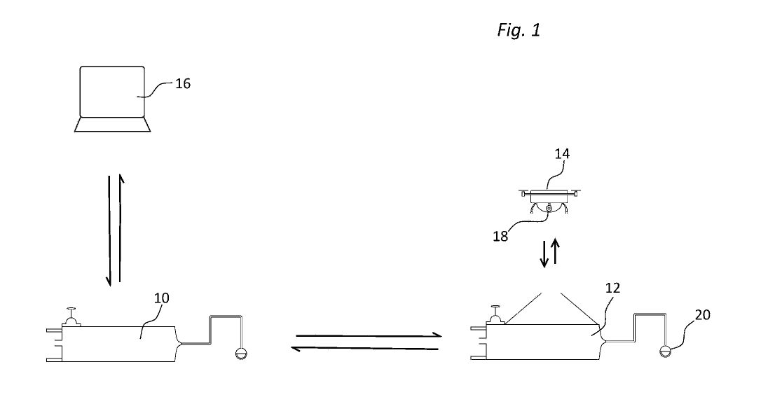

Referring to the invention in more details, FIG. 1 shows the functional relation between the nest 12 and the drone 14 of the device 10 with each other, and with the operator 16. During the dormant stage, the drone 14 is incubated within the nest 12. The device 10 uses the secondary camera 20 of the nest 12 to survey the local field. When the dormant stage is shifted to the active stage, the drone 14 takes off and uses its primary camera 18 to survey a wider field, to follow up a certain event, person or the like. The stimulus for the takeoff process can be an order from the operator 16, during a programmed routine flying or in response to data analysis as a part of artificial intelligence. After completion of its mission, the drone 14 returns back by an autopilot navigation system to touchdown and recombine with the nest 12 returning to the dormant stage.

### DESCRIPTION OF THE PREFERRED EMBODIMENTS

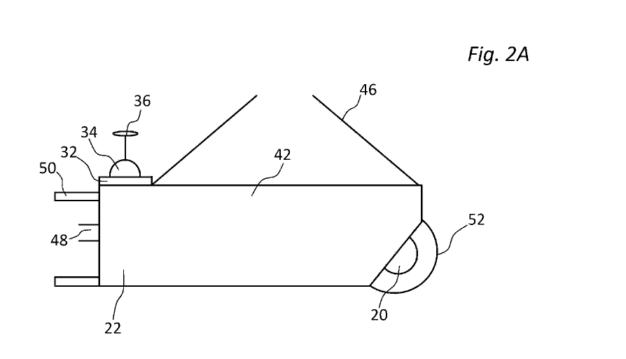

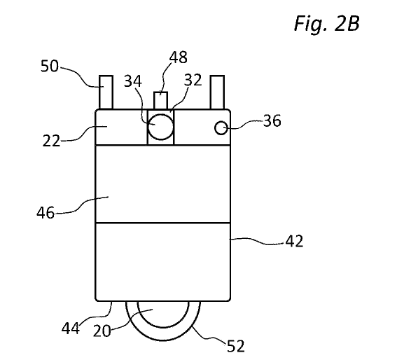

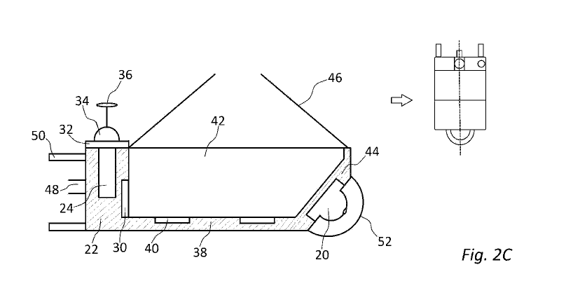

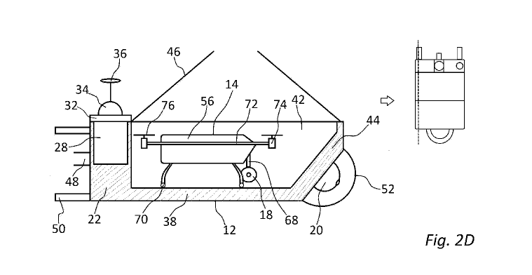

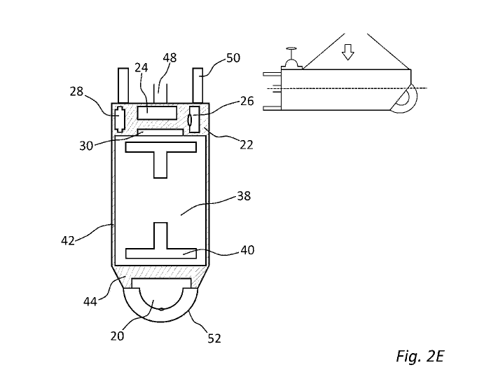

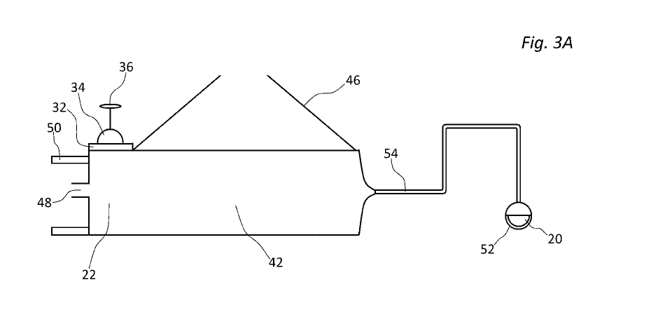

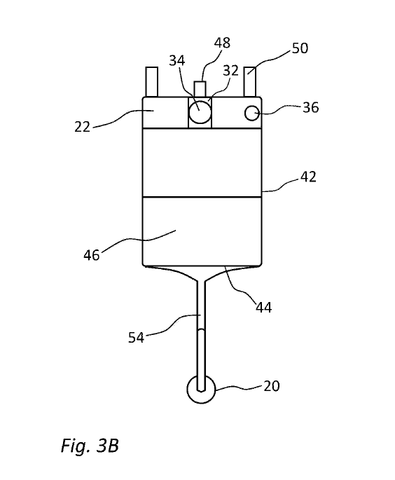

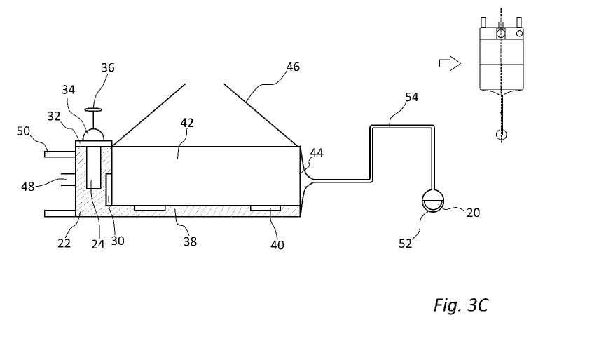

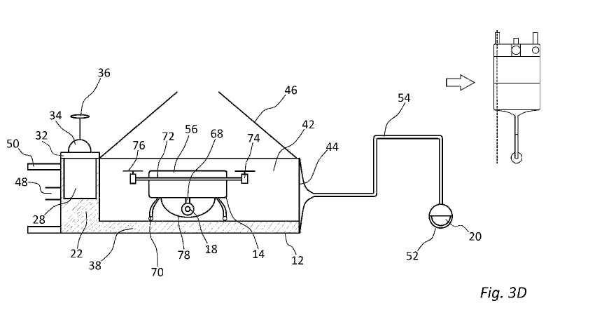

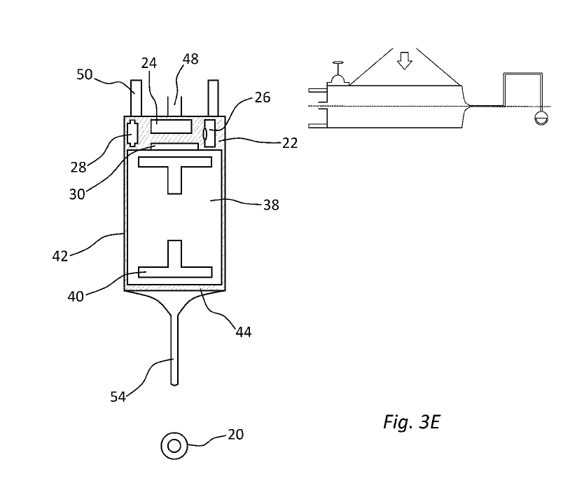

FIGS. 2A to 3E show, in multiple views, parts of the surveillance and tracking device 10. The device 10 comprises mainly the nest 12 and the drone 14 incubated within. The nest 12 helps the drone 14 to maintain functionality by providing power supply, control orders and data stream transfer. The nest 12 holds the secondary camera 20 which surveys the field in which the nest 12 is installed, the local field. The drone 14 is the active element of the device 10 as it holds the primary camera 18 which performs the surveillance process during the active stage. The primary camera 18 moves via gimbals 68 and is isolated by anti-vibration mounts 94. The drone 14 then communicates the data stream to the nest 12 that is considered a connecting link to the operator 16. Control orders of the operator 16 are transmitted to the nest 12 that may directly bypass them to the drone 14 or save them in the control board 24 to maintain functionality during an operator-free process.

Also FIGS. 2A to 3E show, in multiple views, different parts of the nest 12. A bulky body 22 contains sockets that hold other parts of the nest 12. A radio transmitter 26 is inserted in a socket in the body 22, and transmits control orders to a radio receiver 62 on the drone 14. A video receiver 28 also is inserted into another socket in the body 22, and receives data of video stream from a video transmitter 64 on the drone 14. Likewise; the body 22 contains a socket for the control board 24 of the nest 12. This control board 24 is the main hardware of the device 10 and works as a CPU. The board 24 uses the installed firmware to operate the device 10 and to perform principle functions. For example; the board 24 is used as a relay station in the data stream transfer. The control board 24 can analyze data as a part of programmed artificial intelligence. It can process data from the video receiver 28 and sends it to the operator 16. It can process and manipulate control orders from the operator 16 and bypasses them to the radio transmitter 26. It can save the course of routine aviation for the drone 14. In addition, it controls the processes of takeoff and touchdown.

The body 22 of the nest 12 also contains an inductive coil 30 which induces electric current in a receiver coil 60 of the drone 14 to supply electric power and recharging the battery 66. The floor 38 of the nest 12 may house T-shaped electric magnets 40 which help fixation of the drone 14 during the dormant stage inside the nest 12.

The body 22 also has installation pillars 50 that help installation of the device 10 into a wall, a lamppost or the like. The body 22, in its back, has an opening 48 for the cables that responsible for data transfer and power supply of the device 10. The body 22 holds, on the mid of its upper surface, an alarming device 32 with an alarming lamp 34 which perform alarming functions to people in the local field according to the orders of the operator 16 or an installed software. The body 22 also holds an antenna 36 as a communication means. The device 10 depends on GPS for localization purposes of the nest 12 and the drone 14; the operator 16 uses GPS for localization of the devices 10 that may form a surveillance network around a targeted large area, e.g. a city.

The nest 12 has a chamber-like shape, with the body 22 forming the posterior wall in addition to the floor 38 on which the drone 14 rests during the touchdown process and the subsequent dormant stage. The nest 12 also has two lateral walls 42 on both sides. It also has a gate 46 that opens and closes automatically during the takeoff and touchdown processes under control of the control board 24. The nest 12 also has a relatively bulky anterior wall 44 that contains the secondary camera 20 of the nest 12 with its control hardware and firmware, the camera 20 is surrounded by a protective glass 52.

Referring to the views in more details, they highlight the structure of the presented device 10; FIG. 2A is a prospective lateral view that shows the external parts of the device 10. The frontage of the view is taken by the lateral wall 42 and the lateral surface of the body 22 of the nest 12, while the alarm device 32, its lamp 34 and the antenna 36 lie on the upper surface of the body 22. In this view; the automatic gate 46 of the nest 12 are half-opened. This gate 46 is formed of two opposite plates that open and close automatically during the takeoff and touchdown of the drone 14. The installation pillars 50 project from the body 22 of the nest 12 while the back of the body 22 contains the opening 48 of the cables. The secondary camera 20 of the nest 12 is installed into the oblique part of the anterior wall 44 of the nest 12 protected within the protective glass 52. In this position the secondary camera 20 has a wider scope to survey the targeted local field.

FIG. 2B is a prospective superior view that shows, also, the external parts of the device 10. From this view; the roof of the nest 12 which composes of the gate 46 takes the frontage in addition to the superior surface of the body 22 of the nest 12. The alarm device 32 with its lamp 34 are installed into the mid of the upper surface of the body 22 of the nest 12, while the antenna 36 is installed laterally. The secondary camera 20 with its protective glass 52 projects beneath the straight part of the anterior wall 44. The installation pillars 50 are installed into the back of the body 22 of the nest 12, in addition to the opening 48 of the cables.

FIG. 2C is a sectional view of the device 10 showing parts of the empty nest 12. The level of the sectional plane is vertical at the mid of the device 10. The view shows, posteriorly, the bulky body 22 of the nest 12 which contains the control board 24 of the device 10 in addition to the inductive coil 30 of the nest 12 responsible for power supply to the drone 14. The alarm device 32 with its lamp 34 is installed into the upper surface of the body 22 in addition to the antenna 36. The installation pillars 50 are also inserted into the back of the body 22 of the nest 12 which also contains the opening 48 of the cables. The view also shows the floor 38 of the nest 12 which contains the electric magnets 40 responsible for the drone 14 fixation during the dormant stage. The anterior wall 44 houses the secondary camera 20 of the nest 12 with its control hardware and firmware, the camera 20 is surrounded by the protective glass 52. The view also shows the lateral wall 42 and the gate 46.

FIG. 2D is a sectional view of the device 10 showing the nest 12 and the drone 14 within. The level of the sectional plane is vertical at the far lateral side of the device 10. This view shows the chamber-like structure of the nest 12 containing the drone 14. The posterior wall of the chamber is formed by the bulky body 22 of the nest 12. The body 22 of the nest 12 contains, at the level of this view, the video receiver 28 and holds the alarm device 32 with its lamp 34 and the antenna 36 on the upper surface. The installation pillars 50 are inserted into the back of the body 22 which also has the cables' opening 48. The drone 14 rests onto the floor 38 of the nest 12 which contains electric magnets (not shown at the level of the view) that interact with metal plates at the landing skid 70 of the drone 14 helping its fixation during the dormant stage. The anterior wall 44 of the nest 12 is relatively bulky and contains the secondary camera 20 surrounded by its protective glass 52. The view also shows the lateral wall 42 in addition to the roof of the nest 12 which is formed by the automatic gate 46 which opens during the take-off and touchdown of the drone 14.

The drone 14 is formed mainly of a body 56 or a canopy that contains its internal structure, and a frame 72 attached to it. The frame 72 holds electric motors 74 which rotate propellers 76 as shown in the view. The drone 14 rests on the floor 38 of the nest 12 using the landing skid 70 and holds the primary camera 18 via the gimbals 68.

FIG. 2E is a sectional view of the device 10 showing the empty nest 12. The level of the sectional plane is horizontal at the mid of the device 10. This view shows the internal structure of the nest 12. The body 22 contains the control board 24, the radio transmitter 26, the video receiver 28 and the inductive coil 30. And as mentioned before, the control board 24 is the main hardware of the device 10 and contains the software that provides control, monitoring and data manipulation. The radio transmitter 26 and the video receiver 28 are responsible for communication with the drone 14. The inductive coil 30 works as the power supplier for the drone 14. The installation pillars 50 are inserted into the back of the body 22 which houses the cables' opening 48.

The floor 38 of the nest 12 contains two T-shaped electric magnets 40 for the drone 14 fixation purposes during the dormant stage. The anterior wall 44 contains the secondary camera 20 which is surrounded by the protective glass 52. The two lateral walls 42 complete the chamber-like shape of the nest 12.

FIGS. 3A to 3E show an advantageous embodiment of the device 10 in which the anterior wall 44 is modified in shape and function. Instead of holding the secondary camera 20 directly, the anterior wall 44 is modified to hold a pipe which holds the secondary camera 20 at its distal end. Hereinafter; the pipe is called the limb 54 of the nest 12. The aim of this modification is to widen the survey field of the secondary camera 20. The secondary camera 20 is a moving camera so it can survey a larger field, but its installation to the anterior wall 44 of the nest 12 cause movement limitations. The provided method of installation of the secondary camera 20 in this embodiment abolishes this limitation and frees the movement of the camera 20 to a large extent.

FIG. 3A is a prospective lateral view of the device 10. And as is clear; the device 10 looks like the previous preferred embodiment except the modified anterior wall 44. The frontage of the view is occupied by the lateral wall 42 and the lateral surface of the body 22 of the nest 12. The alarm device 32 with its lamp 34 and the antenna 36 are installed into the upper surface of the body 22. The gate 46 appears semi-opened and the installation pillars 50 are inserted into the back of the body 22 which has the cables' opening 48. The major changes happen to the anterior wall 44, from which the limb 54 extends to hold the secondary camera 20 at its distal end. The camera 20 is still protected in the protective glass 52.

FIG. 3B is a prospective superior view of the device 10 showing its external parts. In this view; the closed gate 46 of the nest 12 takes the frontage in addition to the upper surface of the body 22 of the nest 12 which holds, in the mid, the alarm device 32 with its lamp 34. The back of the body 22 is attached to the installation pillars 50 and contains the cables' opening 48. The antenna 36 is installed laterally into the upper surface of the body 22. The modified anterior wall 44 holds, from the superior view, the limb 54 of the nest 12 in which the secondary camera 20 is installed at its distal end.

FIG. 3C is a sectional view of the device 10 showing parts of the empty nest 12. The level of the sectional plane is vertical at the mid of the device 10. This view shows the body 22 of the nest 12 containing the control board 24 and the inductive coil 30. Also the body 22 holds, on its upper surface, the alarm device 32 with its lamp 34 and the antenna 36. The installation pillars 50 are inserted into the back of the body 22 which also has the opening 48 of the cables. The floor 38 of the nest 12 contains the electric magnets 40. The modified anterior wall 44 holds the limb 54 of the nest 12 with the secondary camera 20 installed into its distal end. The lateral wall 42 and the semi-opened gate 46 complete the walls of the chamber-like nest 12.

FIG. 3D is a sectional view of the device 10 showing the nest 12 and the drone 14 within. The level of the sectional plane is vertical at the far lateral side of the device 10. The body 22 of the nest 12, at the level of this view, contains the video receiver 28 and holds, on its upper surface, the alarm device 32 with the alarming lamp 34. The antenna 36 is also installed into the upper surface of the body 22. The installation pillars 50 are projecting from the back of the body 22 which also contains the cables' opening 48. The drone 14 rests on the floor 38 of the nest 12 using its landing skid 70 and covered by the gate 46 which appears in this view semi-opened for distinguishing purposes. The anterior wall 44 is modified to hold the limb 54 in which the secondary camera 20, with its protective glass 52, is installed distally. The lateral wall 42 appears, in this view, behind the drone 14 to complete the chamber-like shape of the nest 12 in which the drone 14 is incubated.

In this view; the drone 14 appears in a different embodiment to indicate that any suitable embodiment of the drone 14 configured to hold the primary camera 18 and fly can be used, in combination with the suitable nest 12, in making the presented device 10. The drone 14, in this view, is formed mainly from the body 56 which houses its internal structure. The frame 72 of the drone 14 is attached to the body 56 and holds the electric motors 74 which rotate the propellers 76. The drone 14 rests on the floor 38 of the nest 12 with the landing skid 70. The primary camera 18 is installed, by its gimbals 68, into the mid of the base of the drone 14 and surrounded by the protective glass 78.

FIG. 3E is a sectional view of the device 10 showing the empty nest 12. The level of the sectional plane is horizontal at the mid of the device 10. The nest 12, in this view, looks like the nest 12 of the preferred embodiment of FIGS. 2A to 2E except the modified anterior wall 44 which holds the limb 54. The secondary camera 20 is installed into the distal end of the limb 54 of the nest 12. In addition to the modified anterior wall 44; the chamber-like structure of the nest 12 is completed by the body 22 posteriorly, the two lateral walls 42, the roof (not shown in this view) and the floor 38 which houses the T-shaped electric magnets 40. The body 22 contains the control board 24, the radio transmitter 26, the video receiver 28 and the inductive coil 30. The installation pillars 50 are inserted into the back of the body 22 which also contains the cables' opening 48.

### Description of Alternative Embodiments

The use of the present invention can vary according to the needs of the customers. It can be used in simple surveillance systems used for home, companies and institutions security, or in advanced police surveillance systems that can survey an entire city. The variation may be structurally in the size and shape of the device 10, and/or functionally depending on the complexity of the used electronic devices and the advancement of the used communication utilities. So, the device 10 can be manufactured in different embodiments that are suitable for every usage.

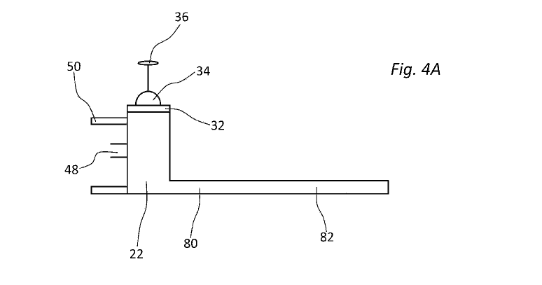

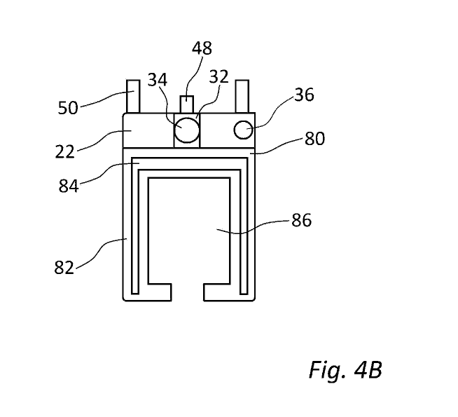

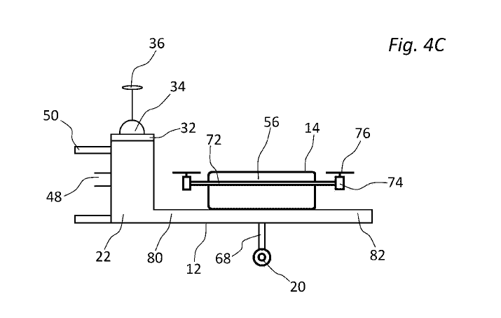

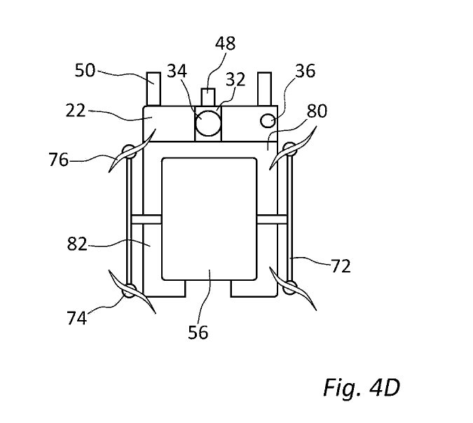

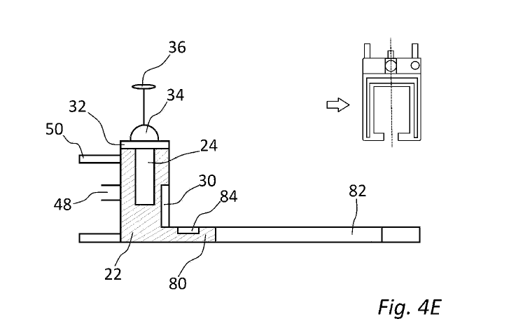

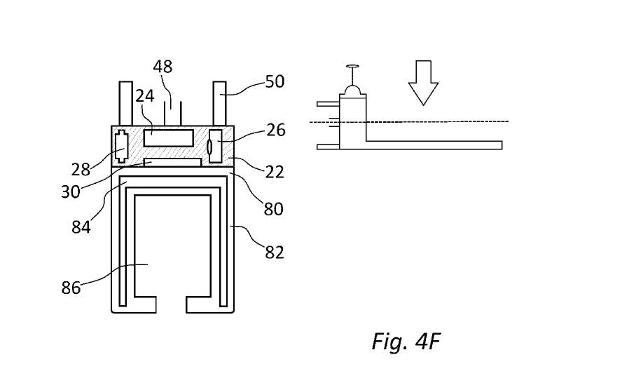

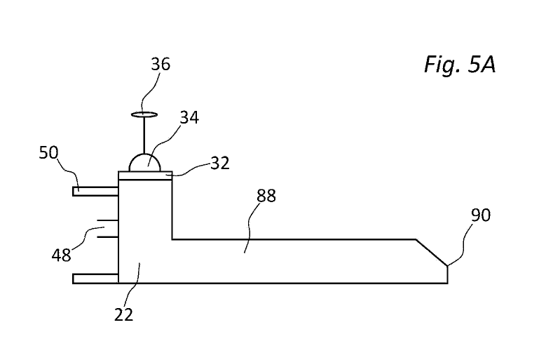

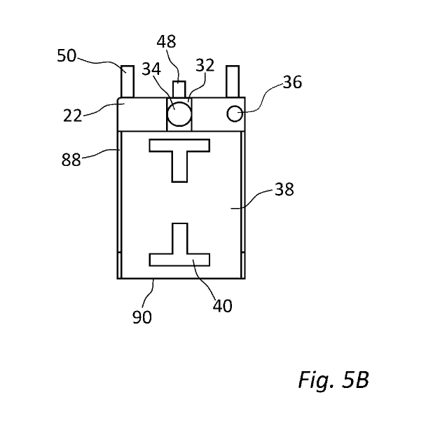

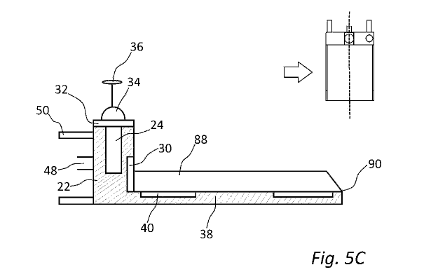

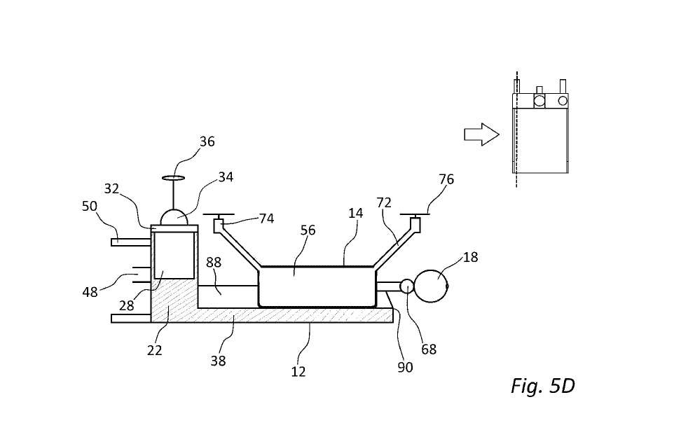

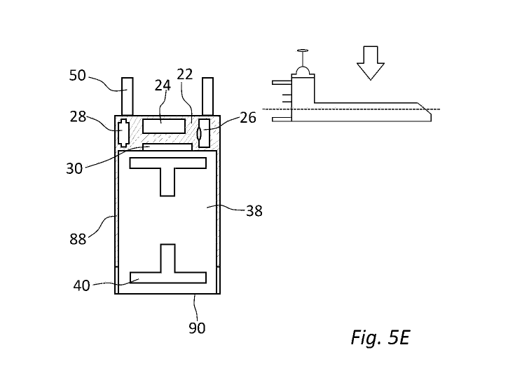

For example; FIGS. 4A to 5E show other relatively small sized, mono-camera embodiments of the device 10. In these embodiments; the primary camera 18 takes additionally the job of the secondary 20 cameras of the previous large embodiments (FIG. 2A to 3E). The primary camera 18 is installed into the drone 14 and finds its way, through modifications in the nest 12 structure, to survey the local field of the device 10 during the dormant stage that was considered the function of the secondary camera 20 of the nest 12 in the previous embodiments. And when the active stage is put into action; the primary camera 18, holding by the flying drone 14, also surveys a wider targeted field to perform its ordinary job in the previous embodiments.

Although these mono-camera embodiments are simpler and smaller, but they have a major drawback as the local field of the device 10 will be a blind spot during the active phase of the device's functionality. In this phase; the drone 14 flies away, holding the active primary camera 18 and the nest 12 has no secondary camera 20 to survey the local field which thus turns to be a blind spot. Another drawback of these embodiments is fixation and protection problems of the drone 14. Due to structure modification of the nest 12, the drone 14 becomes less fixed and protected than the previously mentioned embodiments in which the drone 14 is completely incubated within the nest 12.

FIGS. 4A to 5E show, in multiple views, the mono-camera device 10 which comprises mainly a modified nest 12, and a drone 14. Despite the structural modifications which occur to the nest 12, it keeps its fundamental parts and functions. The nest 12 helps the drone 14 to maintain functionality by providing power supply, control orders and data stream transfer. The drone 14 holds the primary camera 18 which performs the surveillance and tracking processes during both the dormant and active stages. The data stream flows among the drone 14, the nest 12 and the operator 16. The primary camera 18 of the drone 14 provides the operator 16 with a real time videos or photos using the nest 12 as a relay station for the data stream. And the operator 16 provides the drone 14 with control orders using the nest 12 also as a relay station. The data stream can flow between the drone 14 and the nest 12 during the operator-free processes according to the installed software on the control board 24 of the nest 12.

Also FIGS. 4A to 5E show, in multiple views, the preserved major operating parts of the nest 12. The body 22 of the nest 12 contains the control board 24 which works as a CPU and contains the operating firmware. The body 22 also contains the radio transmitter 26 and the video receiver 28 which works as communication units between the nest 12 and the drone 14. The body 22 also contains the inductive coil 30 responsible for power supplying of the drone 14 during the dormant stage. The body 22 also holds, on its upper surface, the alarm device 32 and the alarm lamp 34 which perform alarming functions to people in the local field according to the orders of the operator 16 or the installed software. The antenna 36 is also installed laterally into the upper surface of the body 22. The body 22 has the opening 48 for the cables which are responsible for data transfer and power supply of the device 10. The installation pillars 50 are inserted into the body 22 helping the installation of the device 10 into a wall, a lamppost or the like.

Referring to the views in more details, they highlight the structural modification that occurs in the device 10. FIG. 4A is a prospective lateral view of the device 10 showing the empty nest 12. The figure shows the external parts of the nest 12 after modification. The lateral wall 42, the anterior wall 44 and the roof represented by the gate 46 (of the previous preferred embodiments) are all removed. The view shows only the body 22, the modified floor 38, the alarming device 32, the alarming lamp 34 and the antenna 36. And as usual; the installation pillars 50 are inserted into the back of the body 22 which contains the cable′ opening 48. The floor 38, as appeared in the previous preferred embodiments, is modified in this embodiment. This modification will appear in the upcoming views.

FIG. 4B is a prospective superior view of the device 10 showing the empty nest 12. The figure shows the external parts of the nest 12 after the modification. In this view; the modifications of the floor 38, as appeared in the previous preferred embodiment, are clearly shown. A large hole 86 settles the middle of the floor 38 dividing it into a rectangular base 80 posteriorly, and two lateral horns 82 anteriorly. A U-shaped electric magnet 84 is inserted into the base 80 and the two lateral horns 82 to help fixation of the drone 14 during the dormant stage. The body 22 holds, on its upper surface, the alarming device 32 with its alarming lamp 34 in addition to the antenna 36. The installation pillars 50 are inserted into the back of body 22 which contains the cables' opening 48.

FIG. 4C is a prospective lateral view of the device 10 showing the nest 12 and the drone 14 in combination. The view shows how the drone 14 combines with the nest 12 in this embodiment. The containing function of the nest 12 shifts from the incubation of the drone 14 to be a heliport. The nest 12 has no walls to incubate the drone 14 except the posterior wall which is formed by the body 22. The installation pillars 50 are inserted into the back of body 22 which contains the cables' opening 48. Also; the body 22 still holds, on its upper surface, the alarming device 32 with its alarming lamp 34 in addition to the antenna 36.

The drone 14, in this embodiment, is formed of a body 56 or a canopy which contains the internal structure. The frame 72 is attached to the body 56 of the drone 14 and holds the electric motors 74 that rotate the propellers 76. The primary camera 18 is attached to the inferior base of the body 56 of the drone 14 via the gimbals 68. When the drone 14 rests on the base 80 and the two horns 82 during the dormant stage, the primary camera 18 goes down through the hole 86 and projects from the device 10 inferiorly to scan the local field.

FIG. 4D is a prospective superior view of the device 10 showing the nest 12 and the drone 14 in combination. This view also shows how the drone 14 combines with the nest 12 in this embodiment. In this view; the body 56 of the drone 14 takes the frontage, in addition to the superior surface of the body 22 of the nest 12 posteriorly. The body 56 of the drone 14 is attached to the frame 72 which—in turn—holds the electric motors 74 which rotate the propellers 76. The body 22 of the nest 12 holds, on the mid of its upper surface, the alarm device 32 with its alarm lamp 34. The antenna 36 is installed laterally into the upper surface of the body 22 of the nest 12. The installation pillars 50 are inserted into the back of the body 22 which contains the cables' opening 48.

FIG. 4E is a sectional view of the device 10 showing the empty nest 12. The figure shows parts of the nest 12 from the lateral view. The level of the sectional plane is vertical at the mid of the device 10. The sectional view of the device 10 shows that the nest 12 keeps its main functional parts. The body 22 of the nest 12 contains the control board 24 and the inductive coil 30. The body 22 holds, on its upper surface, the alarm device 32 with its alarm lamp 34 and the antenna 36. The installation pillars 50 are inserted into the back of the body 22 which contains the opening 48 for cables. The view shows the sectioned base 80 attached to the lateral horn 82. The sectioned base 80 contains the electric magnet 84 which helps the fixation of the drone 14 during the dormant stage.

FIG. 4F is a sectional view the device 10 showing the empty nest 12. The figure shows parts of the nest 12 from the superior view. The level of the sectional plane is horizontal at the mid of the device 10. This view shows largely the modifications that take place on the floor 38 (shown in the previous preferred embodiments). The hole 86 lies in the middle of the floor 38 (shown in the previous preferred embodiments), reshaping it into the base 80 attached to the two lateral horns 82. The base 80 with its two lateral horns 82 contains the U-shaped electric magnet 84 that helps fixation of the drone 14 during the dormant stage of the device's functionality. The sectioned body 22, at this view, shows that the nest 12 keeps its main parts. The body 22 contains the control board 24, the radio transmitter 26, the video receiver 28 and the inductive coil 30. The installation pillars 50 are inserted into the back of the body 22 which contains the cables' opening 48.

FIGS. 5A to 5E show another alternative embodiment in which the floor 38 (shown in the preferred embodiment) remains intact, and two lateral fences 88 are installed into the boundaries of the floor 38 to help fixation and protection of the drone 14. The primary camera 18 is installed, via its gimbals 68, into the anterior surface of the body 56 of the drone 14 to survey the local field from a balcony 90 of the nest 12. The insertion of the primary camera 18 into the hole 86 of the nest 12, in the previous embodiment, might be difficult with multiple touchdown/takeoff processes. This embodiment overcomes this possible drawback.

FIG. 5A is a prospective lateral view of the device 10 showing the empty nest 12. The figure shows external parts of the nest 12. The lateral fence 88 appears clearly in this view with the balcony 90 of the nest 12. The body 22 of the nest 12 holds, on its upper surface, the alarm device 32 with the alarm lamp 34 and the antenna 36. The installation pillars 50 are inserted into the back of the body 22 which contains the opening 48 for cables.

FIG. 5B is a prospective superior view of the device 10 showing the empty nest 12. The figure shows external parts of the nest 12. This view shows the intact floor 38 with the T-shaped electric magnets 40. The two lateral fences 88 envelop the floor 38 letting the anterior border free to form the balcony 90 of the nest 12 anteriorly. The body 22 of the nest 12 holds, on the mid of its upper surface, the alarm device 32 with its alarm lamp 34 and the antenna 36. The installation pillars 50 are inserted into the body 22 which contains the cables' opening 48.

FIG. 5C is a sectional view of the device 10 showing the empty nest 12. The figure shows parts of the nest 12 from the lateral view. The level of the sectional plane is vertical at the mid of the device 10. In this view; the lateral fence 88 and the anterior balcony 90 appear clearly. The intact floor 38 contains the electric magnets 40. The body 22 of the nest 12 contains the control board 24 and the inductive coil 30. The body 22 also holds the alarm device 32 with its alarm lamp 34 and the antenna 36. The installation pillars 50 are inserted into the back of the body 22 which contains the opening 48 for cables.

FIG. 5D is a sectional view of the device 10 showing the nest 12 and the drone 14 in combination. The figure shows parts of the nest 12 and the drone 14 from the lateral view. The level of the sectional plane is vertical at the far lateral side of the device 10. In this view; primary camera 18 is installed, via its gimbals 68, into the anterior surface of the body 56 of the drone 14 and looks onto the local field through the balcony 90 of the nest 12. The drone 14 rests on the intact floor 38 and enclosed by the lateral fence 88 at the boundary of the floor 38. The body 56 of the drone 14 forms the frames 72 which—in turn—hold the electric motors 74 that rotate the propellers 76. The body 22 of the nest 12 forms the posterior wall and contains, at the level of this view, the video receiver 28. The body 22 holds, on its upper surface, the alarm device 32 with its alarm lamp 34 and the antenna 36. The installation pillars 50 are inserted into the back of the body 22 which contains the cables' opening 48.

FIG. 5E is a sectional view of the device 10 showing the empty nest 12. The figure shows parts of the nest 12 from the superior view. The level of the sectional plane is horizontal at the mid of the device 10. The main aim of this view is to show that the body 22 of the nest 12 maintains its fundamental parts in this embodiment. The body 22 contains the control board 24, the radio transmitter 26, the video receiver 28 and the inductive coil 30. The installation pillars 50 are inserted into the back of the body 22 which contains the cables' opening 48. The intact floor 38 contains the opposed T-shaped electric magnets 40 and enveloped by the two lateral fences 88 letting the balcony 90 anteriorly.

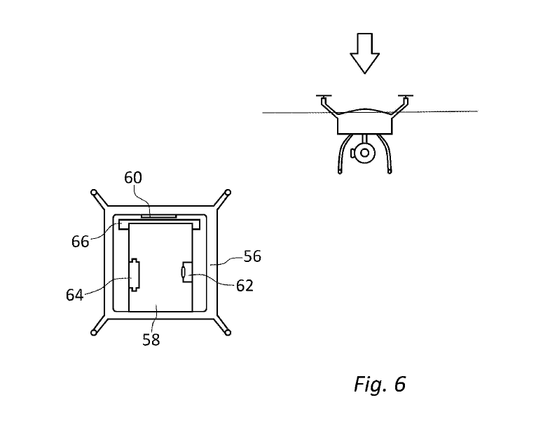

FIG. 6 is a sectional view of the drone 14 showing parts from the superior view. The sectional plane is horizontal, removing the majority of the upper surface of the body 56 of the drone 14. The inner parts shown in this figure are that which related to the interaction between the drone 14 and the nest 12, and thus these which are responsible for the communication, powering, and control. The figure shows the radio receiver 62 and the video transmitter 64 which are the communication units, responsible for communication between the drone 14 and the nest 12. The radio receiver 62 receives control and navigation orders from the radio transmitter 26 of the nest 12. The video transmitter 64 sends the data stream to the video receiver 28 of the nest 12 to update the operator 16 with real time video captured by the primary camera 18.

The figure also shows the receiver coil 60 which generates induced electric current to recharge the battery 66 of the drone 14 during the dormant stage of the device 10 functionality. The inducer of the electric current is the inductive coil 30 of the nest 12. The battery 66 powers the drone 14, via a power distribution board (not shown); during the active stage of the device 10 functionality. In the middle of the canopy or body 56 of the drone 14 lies the flight control board 58 which responsible for manipulating and processing of the control and navigation orders received from the nest 12.

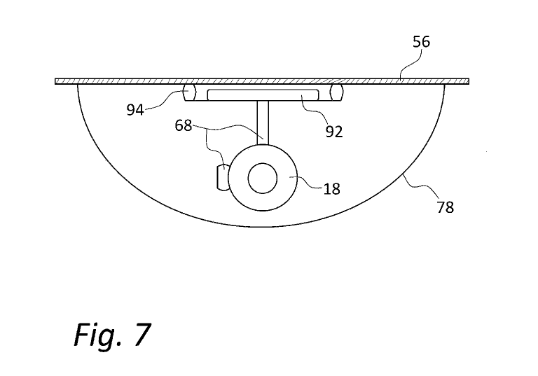

FIG. 7 is a partial view of the drone 14 showing the primary camera 18. As shown, the primary camera 18 is attached via the gimbals 68 into the control board 92 which contains the firmware that operates the camera 18. The whole camera 18 is installed into the body 56 of the drone 14 via anti-vibration mounts 94 which protects the camera 18 from vibrations during the navigation to help the camera 18 capturing clear video and photos.

FIGS. 8A to 8D show, in multiple views, that the nest 12 (or station), presented as a component of the present invention, can be configured to standalone as a separate apparatus 110 used for the stationing of drones to maintain their functionality. In the preferred embodiment; the configured apparatus 110 is a chamber-like structure comprises a bulky body 112 posteriorly, attached to a floor 114 and two lateral walls 116. The chamber-like structure is completed by an anterior wall 118 and an automatic gate 120 which represents the roof. The apparatus 110 has installation pillars 134 inserted into the back of the body 112 to help installation of the apparatus 110 to a wall, a lamppost or the like. The body 112 also contains cables' opening 136.

The bulky body 112 comprises an inductive coil 128 which represents a charger that induces an electric current in a receiver coil installed in the drone (not shown). The body 112 also houses a means of communication which comprises a radio transmitter 124 and a video receiver 126. The body 112 also houses a control board 122 which contains the firmware responsible for operating the apparatus 110. The floor 114 may house electric magnets 132 which help fixation of the drone during the stationing process.

Referring to the views in more details, they highlight the structure of the standalone apparatus 110. FIG. 8A is a prospective lateral view of the apparatus 110 showing the external parts. From the lateral view; the lateral wall 116 takes the frontage in addition to the lateral surface of the body 112. The gate 120 appears semi-opened and formed by two plates, one of them attached to the body 112 posteriorly and the other attached to the anterior wall 118 anteriorly. The antenna 130 is installed into the upper surface of the body 112 which contains the cables' opening 136. The installation pillars 134 are inserted into the back of the body 112 of the apparatus 110.

FIG. 8B is a prospective superior view of the apparatus 110 showing the external parts. From the superior view; the gate 120 and the upper surface of the body 112 take the frontage. The two-plated gate 120 rests upon the two lateral walls 116 wherein the anterior plate attached to the anterior wall 118 and the posterior plate attached to the body 112. The antenna 130 is installed into the upper surface of the body 112. The installation pillars 134 are inserted into the back of the body 112 which houses the cables' opening 136.

FIG. 8C is a sectional view of the apparatus 110 showing its parts from the lateral view. The level of the sectional plane is vertical at the middle of the apparatus 110. The view shows posteriorly the bulky body 112 which houses the control board 122 and the inductive coil 128. The installation pillars 134 are inserted into the back of the body 112 which contains the cables' opening 136. Into the upper surface of the body 112, the antenna 130 is installed. The chamber-like structure of the apparatus 110 is completed by the anterior wall 118, the lateral wall 116, the floor 114 and the gate 120. The floor 114 houses two electric magnets 132.

FIG. 8D is a sectional view of the apparatus 110 showing its parts from the superior view. The sectional plane is horizontal at the middle of the apparatus 110. The view shows the internal structure of the apparatus 110. The body 112 comprises the control board 122, the radio transmitter 124, the video receiver 126 and the inductive coil 128. The installation pillars 134 also are inserted into the back of the body 112 which contains the opening 136 of the cables. The floor 114 of the apparatus 110 houses two electric magnets 132. The chamber-like structure of the apparatus 110, in this view, is completed by the two lateral walls 116 and the anterior wall 118.

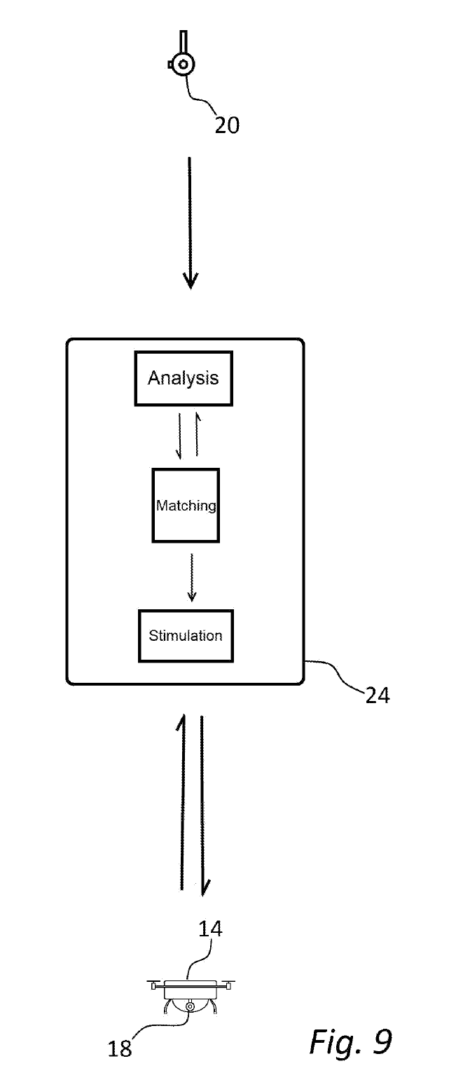

FIG. 9 is a schematic view showing a method of surveillance and tracking process. In the preferred embodiment; the process starts with the passive surveillance phase, wherein the secondary camera 20 performs a surveillance process for the local field in which the device 10 is installed. Then; the data are transmitted to the control board 24 of the nest 12. The data is analyzed by the control board 24 according to the installed software. The analyzed data is matched with the saved data of the software. When the matching process occurs, by a certain percentage predetermined by the operator 16, stimulation of the active surveillance phase occurs. The active surveillance phase represented by launching of the drone 14 which holds the primary camera 18 which—in turn—surveys and tracks the stimulator. The data captured by the primary camera 18 are transmitted back to the control board 24 of the nest 12.

In the mono camera embodiment; the action performed by the secondary camera 20 is performed by the primary camera 18. The passive surveillance process is performed by the primary camera 18 and data is transmitted to the control board 24 of the nest 12. Analysis and matching processes are performed. When matching occurs, the active surveillance phase is stimulated. The drone 14 is launched and the primary camera 18 performs surveillance and tracking process of the stimulator. The data captured by the primary camera 18 is then transmitted to the control board 24 of the nest 12 as a relay station between the drone 14 and the operator 16. The software, that performs the analysis and matching processes, can be installed on the control board 24 of the nest 12 in the preferred embodiment, or the control board 58 of the drone 14 in another embodiment.

Operation of the Invention:
(a) Operation of the preferred and advantageous embodiments of FIGS. 2A to 3E:
   Referring to the operation of the preferred embodiments of FIGS. 2A to 3E; the functionality of the device 10 alters between two different stages, dormant and active. First of all, the device 10 is installed using the installation pillars 50 into a lamppost, a wall or the like and supplied with cables through the cable's opening 48. When the device 10 is put into action, the dormant stage begins. The operation of the device 10 can be divided into steps as follows:
   The dormant stage:
   The secondary camera 20 surveys the local field and transmits data of video stream to the control board 24 of the nest 12 which—in turn—processes data and forward them to the operator 16. During this stage; the drone 14 is incubated within the nest 12 and receives inductive power supply to recharge its battery 66.
   Stimulation of the active stage:
   The active stage can be is stimulated when the control board 24 detects a stimulator, or upon a direct order from the operator 16. Software, which contains a group of stimulators, is installed on the control board 24 of the nest 12. Said software initiates the active stage automatically when the processed data of the secondary camera 20 contain one or more of the pre-saved stimulators.
   The active stage:
   When the active stage is put into action, the control board 24 opens the gate 46 of the nest 12 and turns the drone 14 on. The drone 14 flies away and receives control orders from the operator 16, or from the control board 24 in automatic operator-free process. Control orders are sent to the drone 14 using the radio transmitter 26 of the nest 12 which sends data to the radio receiver 62 of the drone 14. The drone 14 can perform active surveillance during routine flying processes. The drone 14 can also follow up certain targeted events or persons according to the desire of the operator 16, or follow up what was detected as a stimulator by the software of the control board 24. The primary camera 18 of the drone 14 provides the operator 16 with real time video and photos of the target. The data stream transmission is maintained using the video transmitter 64 of the drone 14 and the video receiver 28 of the nest 12.
   Termination of the active stage:
   The active stage is terminated upon direct order of the operator 16, or when the target is out of the aviation field of the drone 14. When the device 10 is an element of an interconnected network of devices, the target steps out from the aviation field of a device to enter the aviation field of another. Upon termination of the active stage, the drone 14 returns back by the autopilot navigation system to be re-incubated within the nest 12 and to restart the dormant stage.
(b) Operation of the alternative embodiments of FIGS. 4A to 5E:
   Referring to the operation of the alternative embodiments of FIGS. 4A to 5E; the functionality of the device 10, in these alternative embodiments, is also alters between two stages, dormant and active. The previously mentioned operational steps are applied to these alternative embodiments. However; they are smaller and contain only one camera which is the primary camera 18 installed into the drone 14. Instead of using two cameras, the primary camera 18 performs the jobs of both cameras of the previous preferred embodiments.
   The dormant stage:
   During this stage, the drone 14 is combined with the modified nest 12 to receive the inductive power supply. The primary camera 18, although installed into the drone 14, finds its way through structural modifications of the nest 12 to survey the local field. Data are transmitted to the control board 24 to be processed, then are forwarded to the operator 16.
   The stimulation of the active stage:
   The stimulation of active stage is similar to the previously mentioned stimulation process.
   The active stage:
   Upon activation, the control board 24 turns on the drone 14 and then cuts power from the electric magnets (either T-shaped 40 or U-shaped 84), so that the drone 14 takes off. The drone 14 flies away, holding the primary camera 18 to survey and follow up the targeted event or person, and so updates the operator 16 with real time videos and photos as previously mentioned.
   Termination of the active stage:
   The termination of the active stage is similar to the previously mentioned termination process.
(c) The operational relation between the nest 12 and the drone 14:
   In all the previously presented embodiments of the device 10 the relation between the nest 12 and the drone 14 is distinguished by four main processes; control process, communication process, powering process and protection and fixation of the drone 14 which uses the nest 12 as a shelter during the dormant stage of the device's functionality.
   The control process occurs mainly using the software of the device 10 installed on the control board 24 which manipulate orders from the operator 16 and bypass them to the drone 14 or save them for future operator-free aviation. The operator-free aviation can be a programmed routine fly of the drone 14 or spontaneous to follow up an event, a person or the like as a part of artificial intelligence that detect dangerous situations.
   The powering process, during the dormant stage, can occur via wireless or inductive powering. The body 22 of the nest 12 contains a wireless, or inductive, powering source for the drone 14. The body 22 houses an inductive coil 30 which induces an electric current in a receiver coil 60 of the drone 14 to supply electric power and recharging battery 66. The device 10 uses cables, which pass through the cables' opening 48 in the back of the body 22 of the nest 12, to maintain continuous power supply.
   The communication process between the drone 14 and the nest 12 occurs via the communication units of the device 10. The video receiver 28 of the nest 12 and the transmitter 64 of the drone 14 are responsible for continuous video's stream transfer between the nest 12 and the drone 14. Additionally; the radio transmitter 26 and the receiver 62 of the drone 14 are responsible for continuous orders' stream transfer between the nest 12 and the drone 14. Theses communication units can come in the form of separate components or can be integrated within the control board 24 of the nest 12 and the flight control board 58 of the drone 14. The device 10 then uses cables, which pass through the opening 48 in the back of the body 22 of the nest 12, to maintain a continuous data stream transfer with the operator 16. In an alternative embodiment; the data stream transfer to the third part, the operator 16, can occur via telecommunication instead of cables in a complete wireless communication among the components of the surveillance process; the operator 16, the nest 12 and the drone 14.
   The fixation of the drone 14 inside the nest 12 (FIGS. 2A to 3E) or in combination with the nest 12 (FIGS. 4A to 5E), occurs via electric magnets 40, 84. These magnets 40, 84 interact with small metal strips (not shown) in the landing skid 70 of the drone 14 (in embodiments of FIGS. 2A to 3E) or the inferior surface of the drone 14 (in embodiments of FIGS. 4A to 5E). The magnetic interaction causes the drone 14 to be fixed. The T-shaped electric magnets 40 or U-shaped electric magnet 84, are all active during both dormant and active stages of the device's functionality. During the dormant stage; the magnets 40, 84 helps fixation of the drone 14. When the active stage is in action the electricity is cut, under the automatic control of the board 24 of the nest 12, so that the magnetic interaction fades away and the drone 14 can takeoff smoothly. After the takeoff process, the magnets 40, 84 can be energized again to help the touchdown process of the drone 14 into/onto the nest 12. In contrast to the previous three vital processes, the fixation process is not essential in the main preferred embodiments of FIGS. 2A to 3E, as the drone 14 can be incubated and well-fixed into the chamber-like shape of the nest 12 in these embodiments.

### CONCLUSION

The present invention is surveillance and tracking device 10 comprises a fixed component, a mobile component and at least one camera. The fixed component is the nest 12 (the station) and the mobile component is the drone 14. The nest 12 helps the drone 14 to maintain functionality by supplying power, control orders and data stream transfer. In the preferred embodiments; the nest 12 holds the secondary camera 20, and the drone 14 holds the primary camera 18. Both cameras update the operator 16 with a real time videos and photos. While the secondary camera 20 of the nest 12 surveys the local field, the primary camera 18 of the drone 14 keeps track of a certain targeted event or person. In alternative embodiments, the device 10 is smaller with only one primary camera 18 installed into the drone 14 that performs the surveillance and tracking processes during both dormant and active stages.

While my above description contains many specificities, these should not be construed as limitations on the scope of the invention, but rather as an exemplification of preferred embodiments thereof. Many other variations are possible. Accordingly, the scope of the invention should be determined not by the embodiments illustrated, but by the appended claims and their legal equivalents.

I claim in:

1. A device for surveillance and tracking, comprising:
a station;
a drone;
at least a camera installed into the drone; and
a charger installed in the station.

2. The device according to claim 1, further comprises:
a means of communication between the station and the drone;
a control board installed in the station;
another camera installed into the station; and
an alarming device installed into the station.

3. The device according to claim 1, wherein the device can be installed into a wall, a lamppost or the like.

4. The device according to claim 1, wherein the charger comprises
an inductive coil installed in the station; and
a receiver coil installed in the drone.

5. The device according to claim 2, wherein the means of communication comprises:
a radio transmitter installed in the station;
a radio receiver installed in the drone;
a video transmitter installed in the drone; and
a video receiver installed in the station.

6. The device according to claims 1 and 2, wherein the two cameras can move via gimbals.

7. The device according to claims 1 and 2, wherein the two cameras can be digital or thermographic.

8. An apparatus for stationing a drone, comprising:
a control board;
a means of communication between the apparatus and the drone; and
a charger.

9. The apparatus according to claim 8, is a chamber-like structure comprising an automatic gate.

10. The apparatus according to claim 8, wherein the means of communication comprises:
a radio transmitter installed in the apparatus;
a radio receiver installed in the drone;
a video transmitter installed in the drone; and
a video receiver installed in the apparatus.

11. The apparatus according to claim 8, wherein the charger comprises
an inductive coil installed in the apparatus; and
a receiver coil installed in the drone.

12. The apparatus according to claim 8, further comprises electric magnets.

13. A method for surveillance and tracking, comprising:
a passive surveillance phase;
analysis of the passive surveillance data using a software; and
stimulation of an active surveillance phase.

14. The method according to claim 13, wherein the analysis step further comprises a matching process between the passive surveillance data and data of the software.

15. The method according to claim 13, wherein the active surveillance is a tracking process using a camera installed into a drone.
